(19) United States
(12) Patent Application Publication
(10) Pub. No.: US 2016/0150446 A1
(43) Pub. Date: May 26, 2016

(54) METHOD AND APPARATUS FOR SUPPORTING ENHANCED SINGLE-RADIO-VOICE-CALL-CONTINUITY

(71) Applicant: NOKIA SOLUTIONS AND NETWORKS OY, Espoo (FI)

(72) Inventor: Juha Matias KALLIO, Vantaa (FI)

(21) Appl. No.: 14/549,029

(22) Filed: Nov. 20, 2014

(51) Int. Cl. H04W 36/00; H04W 8/06; H04L 29/06

(52) U.S. Cl. CPC H04W 36/0055; H04L 65/1006; H04W 8/06

(57) ABSTRACT

A method and apparatus can be configured to transmit, by a Service-Centralization-and-Continuity Application Server, a message to an Access Transfer Control Function. The method may also include receiving an address from the Access Transfer Control Function. The method may also include transmitting the received address to a Home-Subscriber Server. The address is stored as a Session-Transfer Number. The method may also include retrieving information relating to Single-Radio-Voice-Call-Continuity capability. The method may also include retrieving any address that was previously stored as a Session-Transfer-Number.

### BACKGROUND

1. Field

Embodiments of the invention relate to supporting Enhanced Single-Radio-Voice-Call-Continuity functionality that allows a call using a first network to be moved to a second network.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method may include transmitting, by a Service-Centralization-and-Continuity Application Server, a message to an Access Transfer Control Function. The method may also include receiving an address from the Access Transfer Control Function. The method may also include transmitting the received address to a Home-Subscriber Server. The address may be stored as a Session-Transfer Number. The method may also include retrieving information relating to Single-Radio-Voice-Call-Continuity capability. The method may also include retrieving any address that was previously stored as a Session-Transfer-Number.

In the method of the first embodiment, the transmitting the message may comprise transmitting an SIP message.

In the method of the first embodiment, the retrieving the information and the retrieving the any address that was previously stored may include retrieving via an Sh interface.

In the method of the first embodiment, the retrieving the information and the retrieving the any address that was previously stored may include retrieving from the Home-Subscriber Server.

In the method of the first embodiment, the method may further include updating the stored Session-Transfer Number if the address received from the Access Transfer Control Function is different from the address retrieved from the Home-Subscriber Server.

According to a second embodiment, an apparatus may include at least one processor. The apparatus may also include at least one memory including computer program code. The at least one memory and the computer program code may be configured, with the at least one processor, to cause the apparatus at least to transmit a message to an Access Transfer Control Function. The apparatus may also be caused to receive an address from the Access Transfer Control Function. The apparatus may also be caused to transmit the received address to a Home-Subscriber Server. The address may be stored as a Session-Transfer Number. The apparatus may also be caused to retrieve information relating to Single-Radio-Voice-Call-Continuity capability. The apparatus may also be caused to retrieve any address that was previously stored as a Session-Transfer-Number.

In the apparatus of the second embodiment, the transmitting the message may include transmitting an SIP message.

In the apparatus of the second embodiment, the retrieving the information and the retrieving the any address that was previously stored may include retrieving via an Sh interface.

In the apparatus of the second embodiment, the retrieving the information and the retrieving the any address that was previously stored may include retrieving from the Home-Subscriber Server.

In the apparatus of the second embodiment, the apparatus may be further caused to update the stored Session-Transfer Number if the address received from the Access Transfer Control Function is different from the address retrieved from the Home-Subscriber Server.

According to a third embodiment, a computer program product may be embodied on a non-transitory computer readable medium. The computer program product may be configured to control a processor to perform a process including transmitting, by a Service-Centralization-and-Continuity Application Server, a message to an Access Transfer Control Function. The process may also include receiving an address from the Access Transfer Control Function. The process may also include transmitting the received address to a Home-Subscriber Server. The address may be stored as a Session-Transfer Number. The process may also include retrieving information relating to Single-Radio-Voice-Call-Continuity capability. The process may also include retrieving any address that was previously stored as a Session-Transfer-Number.

In the computer program product of the third embodiment, the transmitting the message may include transmitting an SIP message.

In the computer program product of the third embodiment, the retrieving the information and the retrieving the any address that was previously stored may include retrieving via an Sh interface.

In the computer program product of the third embodiment, the retrieving the information and the retrieving the any address that was previously stored may include retrieving from the Home-Subscriber Server.

In the computer program product of the third embodiment, the process may further include updating the stored Session-Transfer Number if the address received from the Access Transfer Control Function is different from the address retrieved from the Home-Subscriber Server.

### BRIEF DESCRIPTION OF THE DRAWINGS

For proper understanding of the invention, reference should be made to the accompanying drawings, wherein:

FIG. 1 illustrates a high-level messaging procedure between an Evolved-Packet-System and a Circuit-Switched network (1xCS).

FIG. 2 illustrates an architecture for implementing Single-Radio-Voice-Call-Continuity (SRVCC) from Evolved UMTS Terrestrial-Radio-Access-Network (E-UTRAN) to 1xCS.

FIG. 3 illustrates using a media path after enhanced SRVCC has occurred.

FIGS. 4A and 4B illustrate a message flow for implementing SRVCC from E-UTRAN to 1xCS.

FIG. 5 illustrates a message flow for performing IP Multimedia Subsystem (IMS) registration.

FIG. 6 illustrates a message flow for implementing SRVCC from E-UTRAN to 1xCS in accordance with certain embodiments of the present invention.

FIG. 7 illustrates a message flow for implementing SRVCC from E-UTRAN to 1xCS in accordance with certain embodiments of the present invention.

FIG. 8 illustrates a flowchart of a method in accordance with embodiments of the invention.

FIG. 9 illustrates an apparatus in accordance with embodiments of the invention.

FIG. 10 illustrates another apparatus in accordance with embodiments of the invention.

FIG. 11 illustrates another apparatus in accordance with embodiments of the invention.

### DETAILED DESCRIPTION

Embodiments of the invention relate to supporting Enhanced Single-Radio-Voice-Call-Continuity functionality that allows a call using a first network to be moved to a second network. For example, embodiments of the present invention may relate to supporting Enhanced Single-Radio-Voice-Call-Continuity functionality that allows a call using an Evolved Universal-Mobile-Telecommunications-System Terrestrial Radio Access Network to be moved to a Circuit Switched Core Network. 3GPP has defined a Single Radio Voice Call Continuity (SRVCC) procedure for enabling the continuity of a voice-session/call of a User Equipment (UE), where the UE is currently performing calls using radio access, and the UE does not support the simultaneous use of dual-radio technologies.

3GPP Technical Specification (TS) 23.216 defines the stage 2 procedures for SRVCC. Both 3GPP and 3GPP2 specification define procedures for enabling SRVCC functionality that allows a call using an Evolved-UMTS-Terrestrial-Radio-Access-Network (E-UTRAN) to be moved to a 1xCS (Code-Division-Multiple-Access) circuit-switched network.

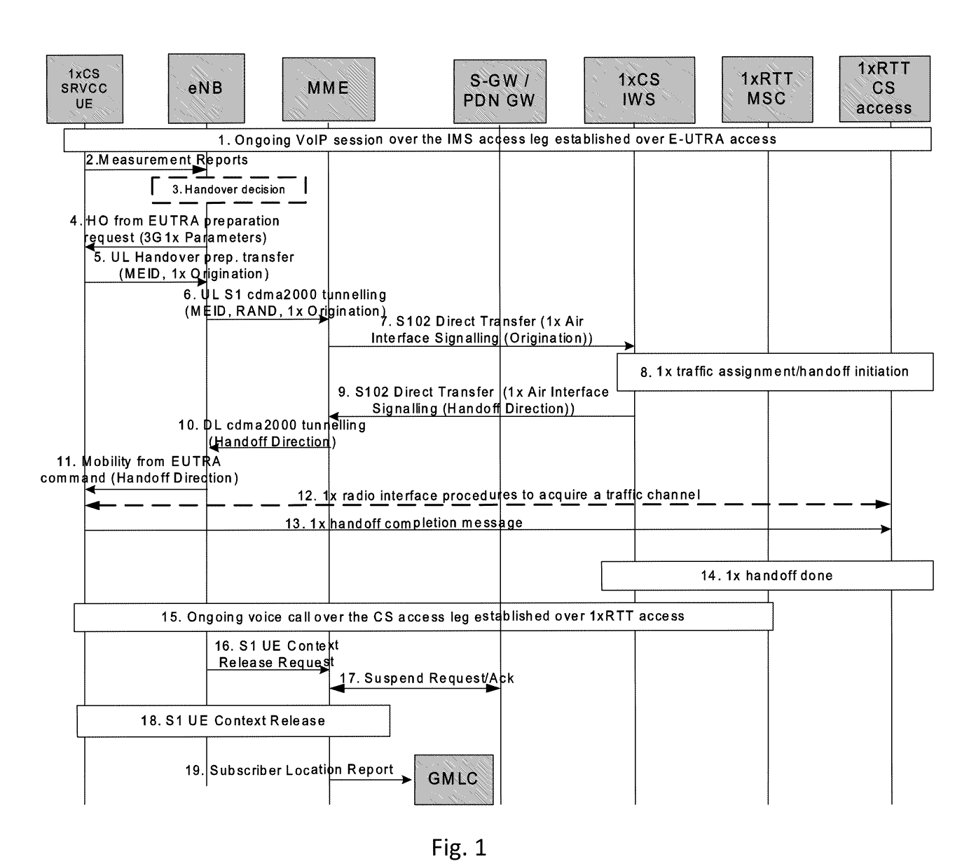

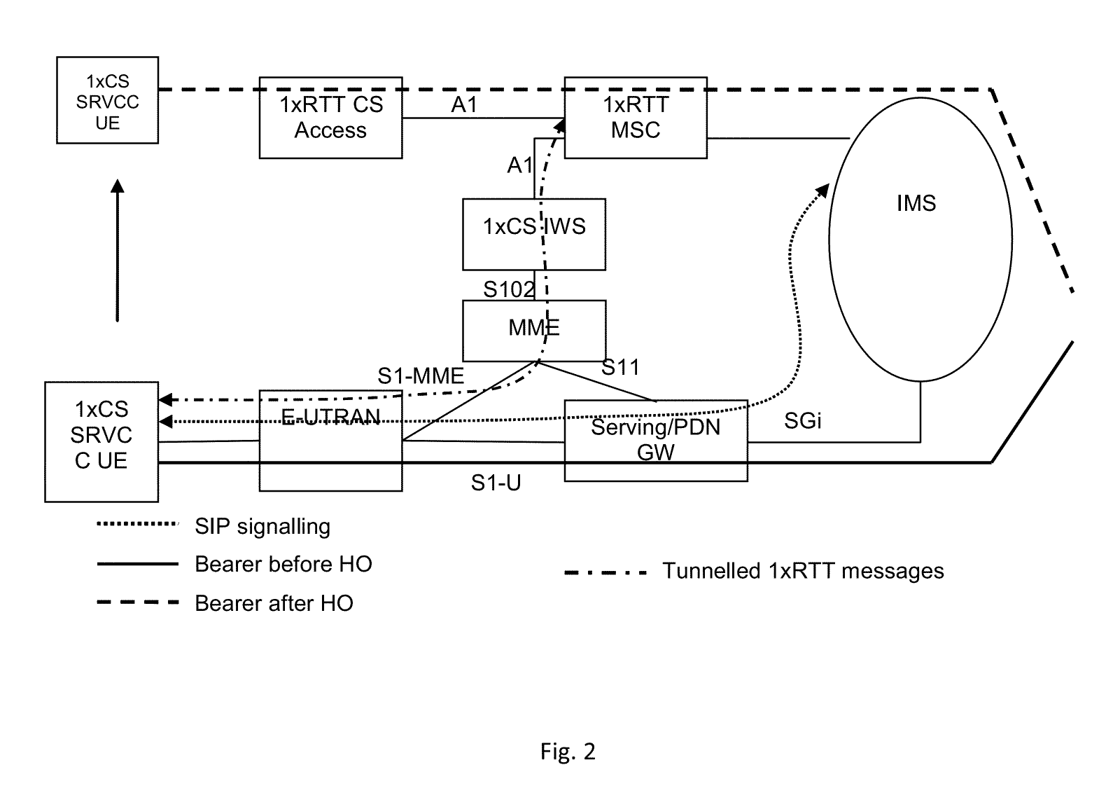

FIG. 1 illustrates a high-level messaging procedure between an Evolved-Packet-System and a Circuit-Switched network (1xCS). FIG. 2 illustrates an architecture for implementing Single-Radio-Voice-Call-Continuity (SRVCC) from Evolved UMTS Terrestrial-Radio-Access-Network (E-UTRAN) to 1xCS. FIGS. 1 and 2 illustrate high-level messaging procedures. 3GPP TS 23.216 defines the stage 2 procedures, which includes defining high-level messaging procedures that are used in conjunction with an Evolved-Packet-System (EPS) and a 1xCS network (as illustrated by FIG. 1), and that are to be used in conjunction with an overall architecture (as illustrated by FIG. 2) as well.

3GPP TS 29.277 (“Optimized handover procedures and protocol between E-UTRAN access and non-3GPP accesses (S102); Stage 3”) specifies the implementing of an S102 interface between a Mobility Management Entity (MME) and a 1xCS Interworking System (IWS). This S102 interface may be used for both SRVCC and Circuit-Switched (CS) Fallback for an EPS that allows a call using Evolved-Universal-Terrestrial-Radio-Access-Network (E-UTRAN) to be moved to a 1xCS network.

The S102 interface may communicate transparently-tunnelled A21 protocol information from a User Equipment (UE) to a 1xCS Mobile-Switching-Center (MSC), as described in 3GPP2 Specification A.S0008-D (“Interoperability Specification (IOS) for High Rate Packet Data (HRPD) Radio Access Network Interfaces with Session Control in the Access Network”) chapter 5.1.6. The 1xCS IWS connects to the legacy 1xCS Mobile-Switching-Center (MSC) via an A1 interface, and the 1xCS IWS provides interworking between the MME and the 1xCS MSC.

A1 and A21 protocols encapsulate Upper Layer (Layer 3) signalling protocol messages that are defined in 3GPP2 C.S0005-D specification.

Voice Call Continuity procedures are described in 3GPP2 X.S0042-B specification. This specification includes description relating to domain transfer from High-Rate Packet Data (HRPD) VoIP to 1x CS Voice, and the description may also be applicable to implementing SRVCC from E-UTRAN to 1xCS. These procedures may not be defined in 3GPP TS 23.216. These procedures may use 3GPP2 Mobile-Application-Part (MAP) protocol procedures, as defined in 3GPP2 X.S0004-550-E.

In comparison to a 3GPP variant of SRVCC functionality (which allows a call using E-UTRAN to be moved to the 3GPP CS domain), the 3GPP2 1xCS has a few architectural differences. A first difference between the 3GPP CS and the 3GPP2 1xCS is that, when moving to a 3GPP2 1xCS, a Session Transfer Number for SRVCC (STN-SR) is not transferred from a Home-Subscriber-Server (HSS) to an MME (EPC) via an S6a interface. Thus, the Evolved-Packet Core (EPC) does not provide any Session-Transfer-Number for SRVCC (STN-SR) to the MSC, when SRVCC is invoked. A second difference is that the UE may have a preconfigured VDN (VCC Domain Transfer Directory Number) that the UE uses in a Layer 3 Origination message, which is tunnelled via the 1xCS IWS to a legacy 1xCS MSC. The 1xCS MSC uses this VDN in a subsequent communication with a Voice-Call-Continuity Application Server (VCC AS).

3GPP TR 23.856 (“Single Radio Voice Call Continuity (SRVCC) enhancements; Stage 2”) has defined architectural enhancements in order to optimize the SRVCC by introducing two new network functions into network architecture: (1) an Access Transfer Control Function (ATCF), and (2) an Access Transfer Gateway (ATGW).

ATCF may be involved with the initial IMS registration, and the ATCF decides, per each IP Multimedia Subsystem (IMS) session basis, whether media anchoring is required by an Access Transfer Gateway (ATGW). After an IMS session has been anchored from a media point-of-view to the ATGW located in a serving (current) Public-Land-Mobile-Network (PLMN) of an IMS subscriber, then the ATCF may be able to hide the change of media endpoint Real-Time-Transport-Protocol/RTP-Control-Protocol (RTP/RTCP) from the peer side of an IMS session, if SRVCC occurs. The ATCF may control the ATGW via an Iq/H.248 interface. This may result in a pre-deterministic and a shorter media interruption time as compared to a situation where ATCF/ATGW are not used with SRVCC.

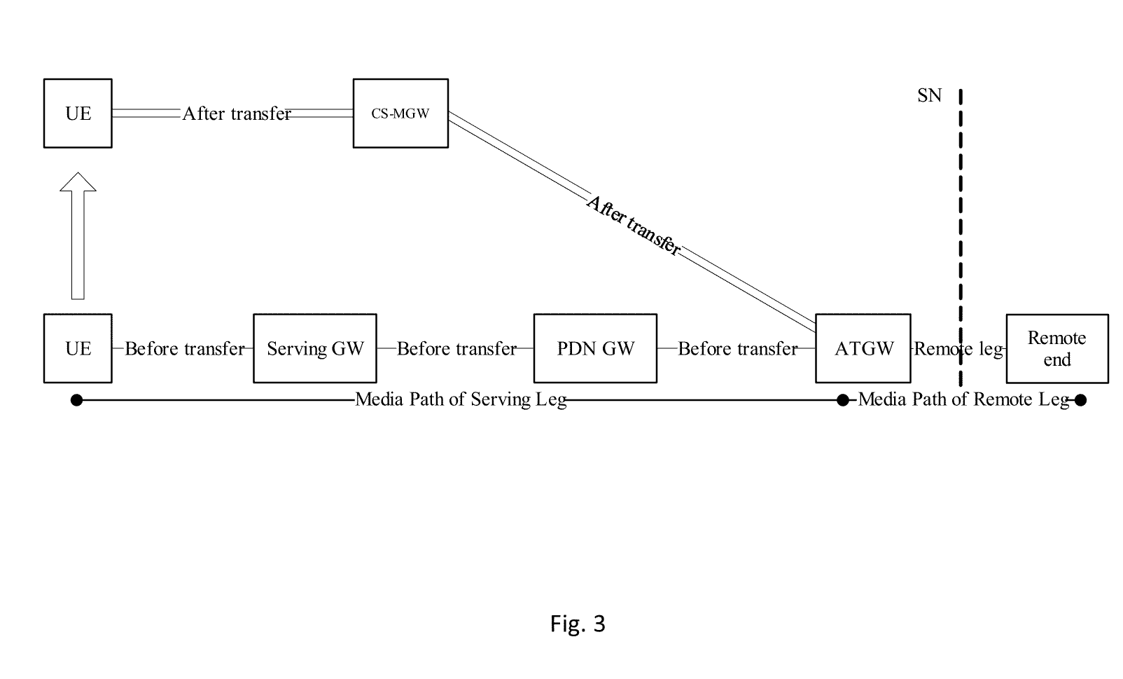

FIG. 3 illustrates using a media path after enhanced SRVCC has occurred. FIG. 3 illustrates a situation after SRVCC has occurred while using ATCF/ATGW.

3GPP TS 23.237 (“IP Multimedia Subsystem (IMS) Service Continuity; Stage 2”) has defined more detailed procedures for enabling session continuity in 3GPP architecture. The stage 3 level dynamic behaviour is described in 3GPP TS 24.237 (“IP Multimedia (IM) Core Network (CN) subsystem IP Multimedia Subsystem (IMS) service continuity; Stage 3”).

However, neither 3GPP nor 3GPP2 has standardized use of ATCF/ATGW in conjunction with implementing SRVCC from E-UTRAN to 1xCS. In practice, if implementation strictly follows the procedures defined in both 3GPP TS 23.216 and 3GPP2 X.S0042-B, then the above-described enhancements gained through use of ATCF/ATGW cannot be achieved. Currently, there may be a non-standardized area between 3GPP and 3GPP2 standards relating to enhanced SRVCC.

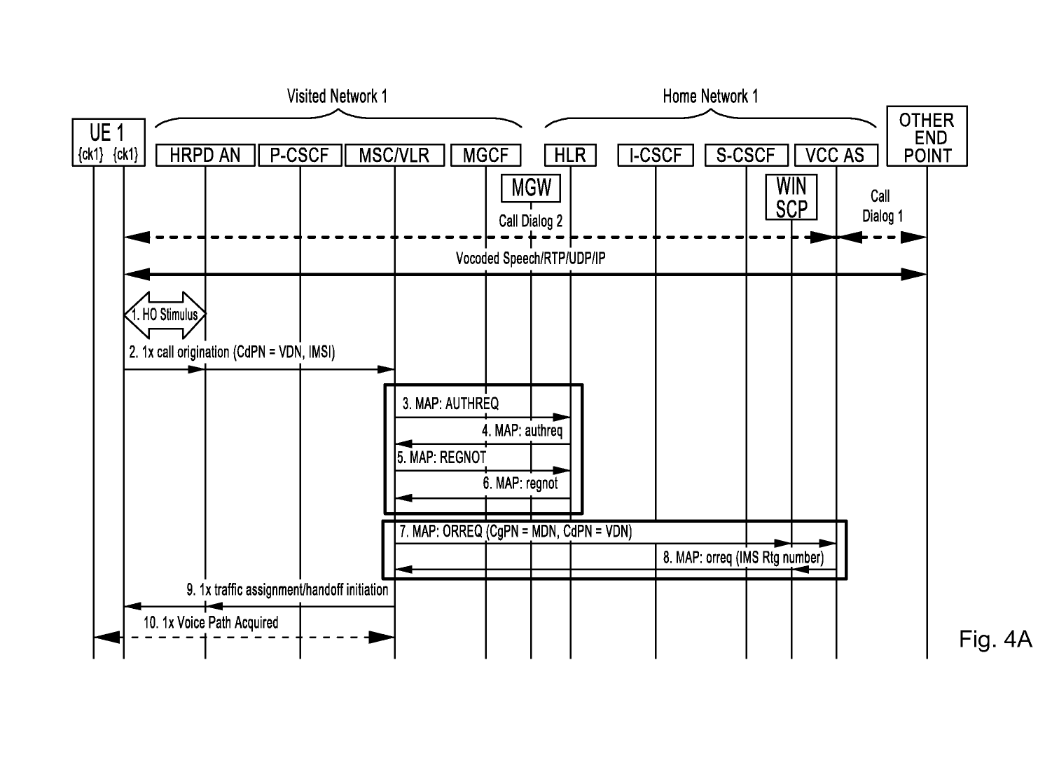

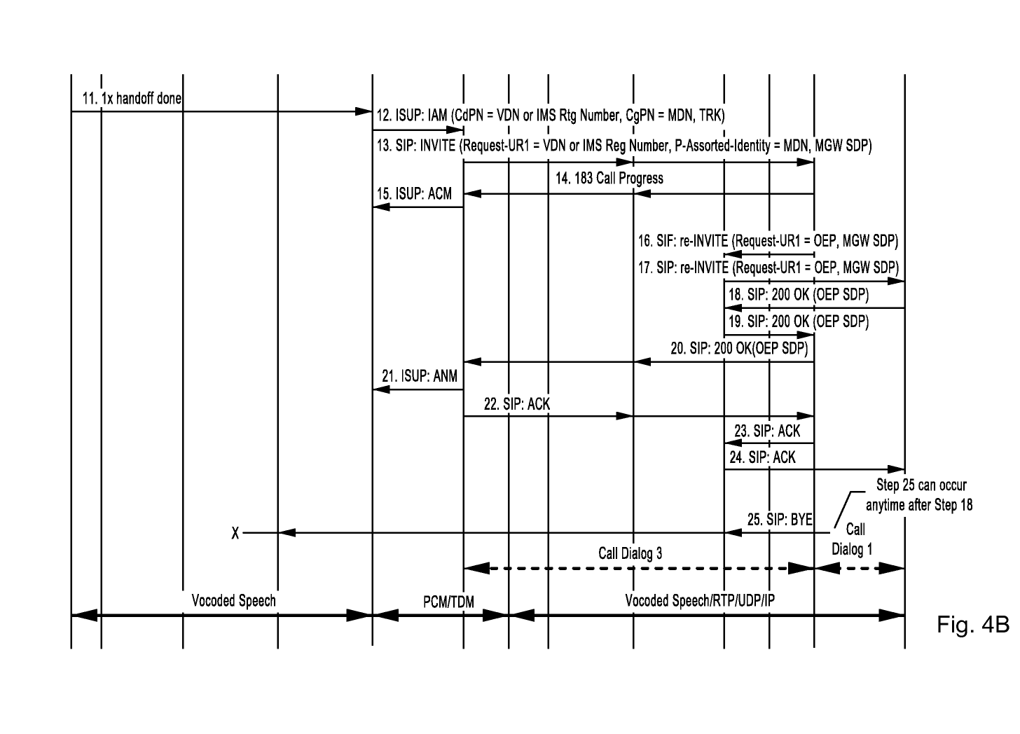

FIG. 4 illustrates a message flow for implementing SRVCC from E-UTRAN to 1xCS. FIG. 4 illustrates a procedure (defined by 3GPP2 specification) which enables implementing VCC from High-Rate-Packet Data (HRPD) to 1xCS. The procedure can also be applied for enabling SRVCC from E-UTRAN to 1xCS.

This procedure may describe how the UE sends the Voice-Call-Continuity-Transfer Directory Number (VDN) as a part of a Called Party Number information (in an Origination message via EPS/1xCS IWS) to a legacy 1xCS MSC. The 1xCS MSC may then use this information to trigger a WIN/MAP procedure towards a Service-Control-Point/VCC AS. As a result of this procedure, the VCC AS may provide a routable E.164 address, which can be used by the 1xCS MSC to route the “session transfer call” to the VCC AS. As such, the VCC AS may modify a media path towards a peer side of an IMS session by sending Re-INVITE with a new Session-Description-Protocol (SDP) offer. The SDP offer may contain the IP address of an RTP peer of an IP-Multimedia-Media-Gateway-Function (IM-MGW) received from MGCF. Finally, the media path may be connected between the IM-MGW and the peer side of IMS session.

Embodiments of the present invention may enable use of ATCF/ATGW. Embodiments of the present invention may enable use of enhanced SRVCC procedures as defined in 3GPP Release-10. Certain embodiments of the present invention may re-use these procedures with SRVCC from E-UTRAN to 1xCS.

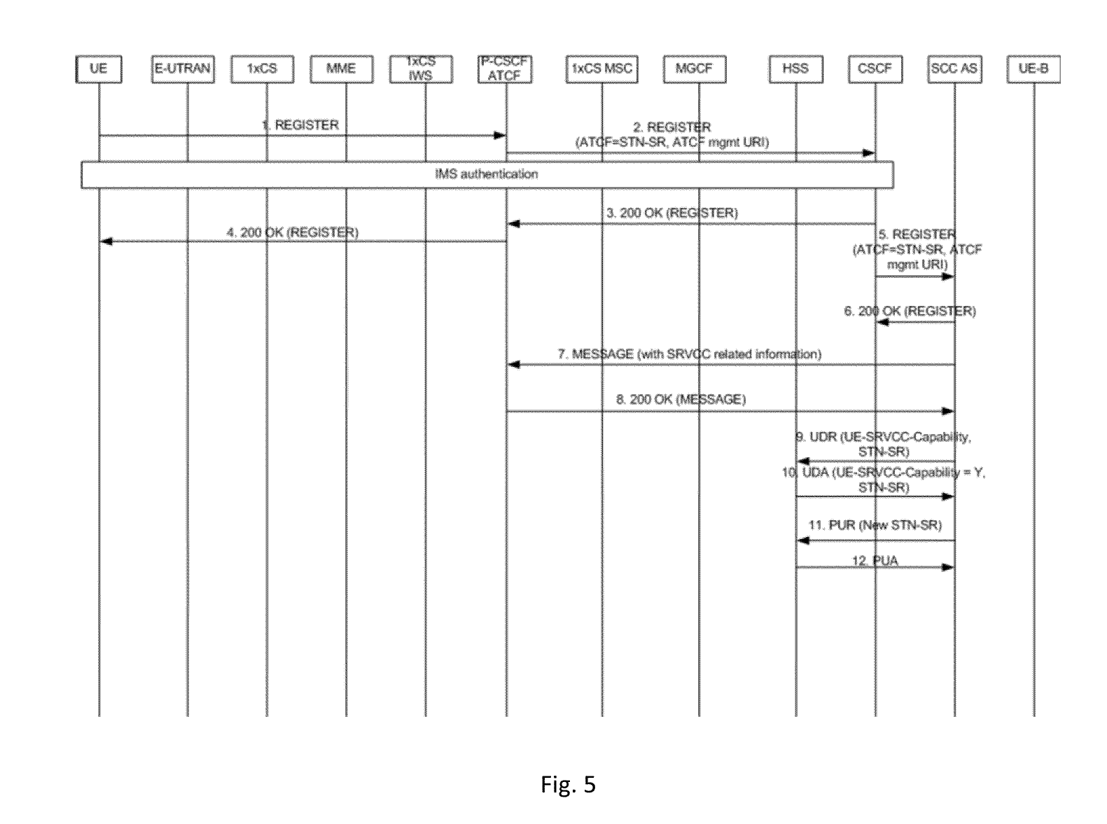

FIG. 5 illustrates a message flow for performing IP Multimedia Subsystem (IMS) registration. With regard to IMS registration, the IMS registration procedure described by 3GPP Release 10 TS 23.237 (and TS 24.237) may be used with a following high level flow. A Proxy-Call-Session-Control-Function (P-CSCF) may involve ATCF (as described in 3GPP TS 23.237) in order to enable enhanced SRVCC functionality as part of the IMS registration. In this case, ATCF allocates an E.164 address that is known as Session Transfer Number-Single Radio (STN-SR). The STN-SR can be used by other network elements (such as 1xCS) to reach the right ATCF in the event of SRVCC (the ATCF may be encoded into a Session-Initiation-Protocol (SIP) REGISTER request as a part of +g.3gpp.atcf feature-caps header).

Also, in case a Service-Centralization-and-Continuity Application Server (SCC AS) supports use of ATCF, then it sends the SIP MESSAGE to ATCF as standardized by 3GPP which contains access transfer information, including Access Transfer Update-Session Transfer Identifier as well as a Common Mobile-Station-International-Subscriber-Directory Number (MSISDN) of a served user. This procedure is described in 3GPP TS 23.237. The SCC AS may store a received ATCF address as the STN-SR within an HSS. Specifically, the SCC AS receives an address from ATCF, and the SCC AS stores this address as the STN-SR within the HSS. The HSS may be used as a persistent storage of this information because the SCC AS may need to be a stateless network function without any state information outside of IMS sessions.

The SCC AS may retrieve the following information from HSS via an Sh interface. The SCC AS may retrieve information relating to UE SRVCC capability, which may be updated by a Mobility-Management Entity (MME). The SCC AS may also retrieve information relating to any existing Session-Transfer-Number-Single-Radio (STN-SR) number stored in the Home Subscriber Server (HSS) prior to this registration. In case the STN-SR stored in the HSS is different than the STN-SR received from ATCF, then the SCC AS may need to update the STN-SR via Sh to the HSS. A difference between the STN-SRs may indicate, for instance, that the ATCF has been changed compared to one used in earlier IMS registration. As such, the IMS registration procedures for the enhanced SRVCC may be completed.

With regard to IMS session establishment, when an IMS session originates from LTE access (VoIP), then ATCF determines whether any media anchoring needs to occur in ATGW. Also, this procedure is described in 3GPP TS 23.237, and TS 24.237 may be applicable in accordance with embodiments of the present invention.

With certain embodiments of the present invention, procedures (as defined in 3GPP TS 23.216) may be followed in an access network (EPC and 1xCS) to perform transferring a call/session from E-UTRAN to 1xCS. The procedures may not require any modification.

With certain embodiments of the present invention, when a 1xCS MSC establishes a call (as described in X.S0042-B), the 1xCS MSC may send a MAP Originating-Request-MAP Message (ORREQ message) towards the WIN-SCP or the VCC AS. The MAP ORREQ message may contain the VDN as a Called Party Number. This triggering may be based on a retrieved service profile from the Home Location Register (HLR). The content of this MAP message may be described in 3GPP2 X.S0004-540-E.

This MAP message may be standardized so that the MAP message may be eventually routed to the VCC AS. The VCC AS may allocate an IMS routing number (IMRN) and may return the IMRN to the 1xCS MSC as part of an ORREQ result to the 1xCS MSC. The 1xCS MSC may use this information to route the call to the VCC AS.

Certain embodiments of the present invention may be directed to an implementation of SCC AS. In order to ensure that the 1xCS MSC will route the session transfer call to ATCF instead of to VCC AS, the following enhancements may be implemented when a session transfer is invoked. The SCC AS/VCC AS may be configured to not locally allocate any “E.164 temporary routing number,” but instead the SCC AS may inquire the STN-SR from the HSS via the Sh interface.

This STN-SR may be the same as was determined by the SCC AS during the IMS registration phase and that was provided by the ATCF network function. SCC AS may decide to provide STN-SR (stored in HSS) based on a local configuration or based on information that the SCC AS has received during the IMS registration/session establishment phase. As an example of such information, a P-Access-Network-Information or a P-Visited-Network-Info header value may indicate a use of E-UTRAN in a serving network that requires use of SRVCC to 1xCS. In certain embodiments of the present invention, the 1xCS MSC uses this ATCF-allocated STN-SR as an IMS Routing Number (IMRN) to route a call via MGCF to ATCF.

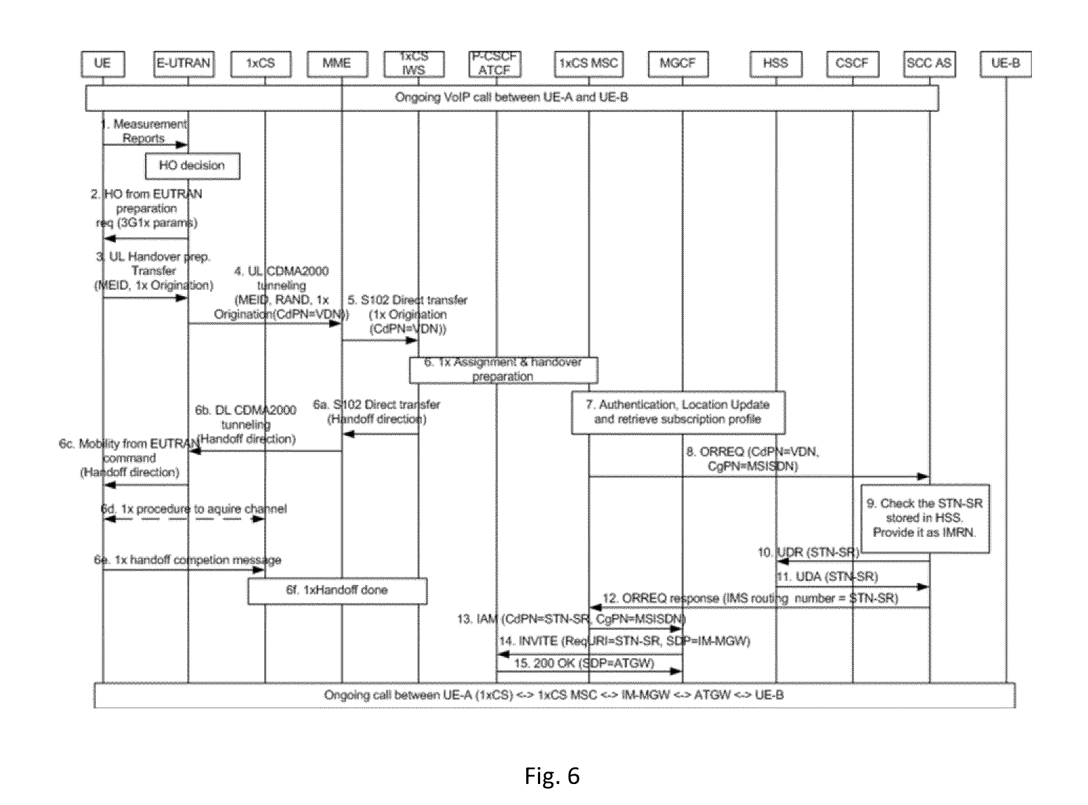

FIG. 6 illustrates a message flow for implementing SRVCC from E-UTRAN to 1xCS in accordance with certain embodiments of the present invention. Referring to FIG. 6, a 1xCS MSC may not have any visibility regarding the ATCF involvement because routing may be based on an IP Multimedia Routing Number (IMRN). The IP Multimedia Routing Number may have an actual value that indicates the ATCF routable address (via MGCF). Also, embodiments of the present invention may possibly not impact the Media-Gateway-Controller Function (MGCF), because the ATCF address may be analyzed by the routing analysis configuration of the MGCF.

Furthermore, the ATCF may not have any specific functionality related to the 1xCS access network. Existing standardized 3GPP TS 23.216, TS 23.237 and TS 24.237 procedures may be applied for SRVCC from E-UTRAN (Packet Switch) to 1xCS (CS). Embodiments of the present invention may limit the impact to the SCC AS/VCC AS. Embodiments of the present invention may cover enhancement options for HSS-based implementation.

In the event that SCC AS/VCC AS does not implement a WIN/IS-41 MAP interface implementation that is required for the SRVCC to 1xCS network, then, as an implementation-specific option, such an interface may be implemented by some other network element such as, for example, an element that implements HSS network functionality.

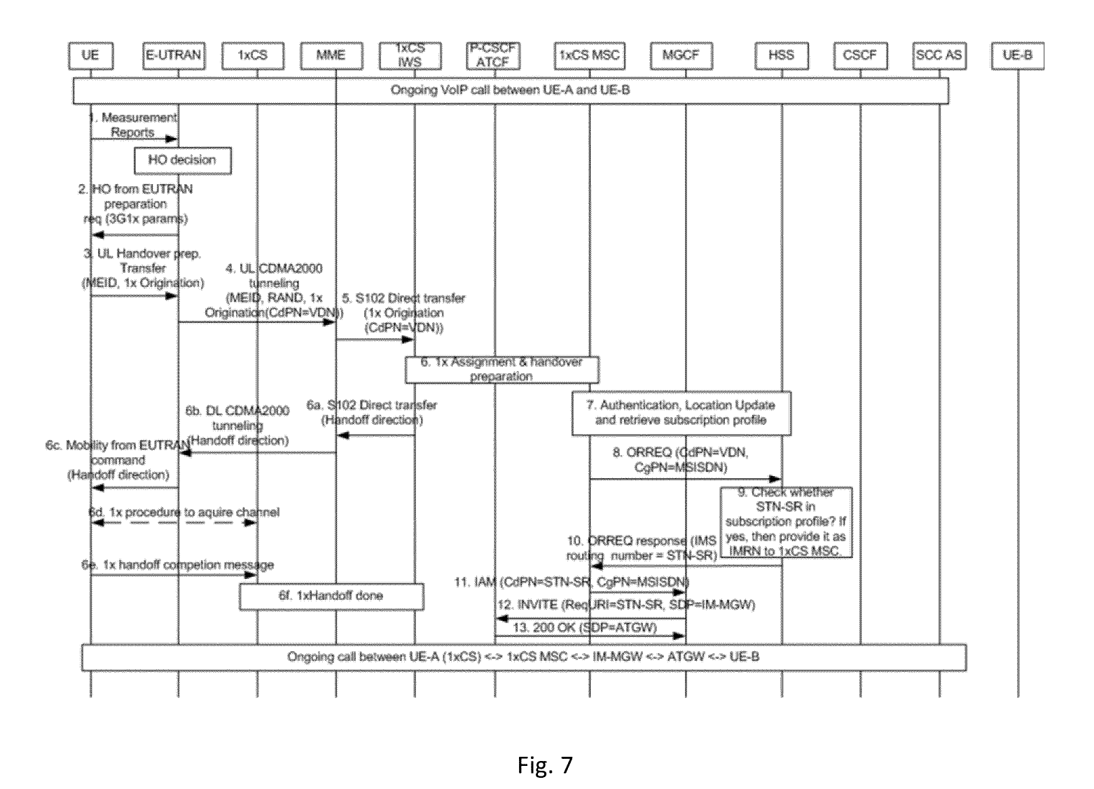

FIG. 7 illustrates a message flow for implementing SRVCC from E-UTRAN to 1xCS in accordance with certain embodiments of the present invention. Referring to FIG. 7, an SCC AS may provide the STN-SR address via an Sh interface to HSS, as standardized by 3GPP. The HSS may return this information as a part of a MAP response to the interrogating 1xCS MSC.

One benefit of the architecture of embodiments of the present invention is that the SCC AS/VCC AS can be kept globally generic, and functionalities that are specific to 3GPP2 may not be required for performing eSRVCC or SRVCC. Embodiments of the present invention may be implemented without substantially impacting the HSS.

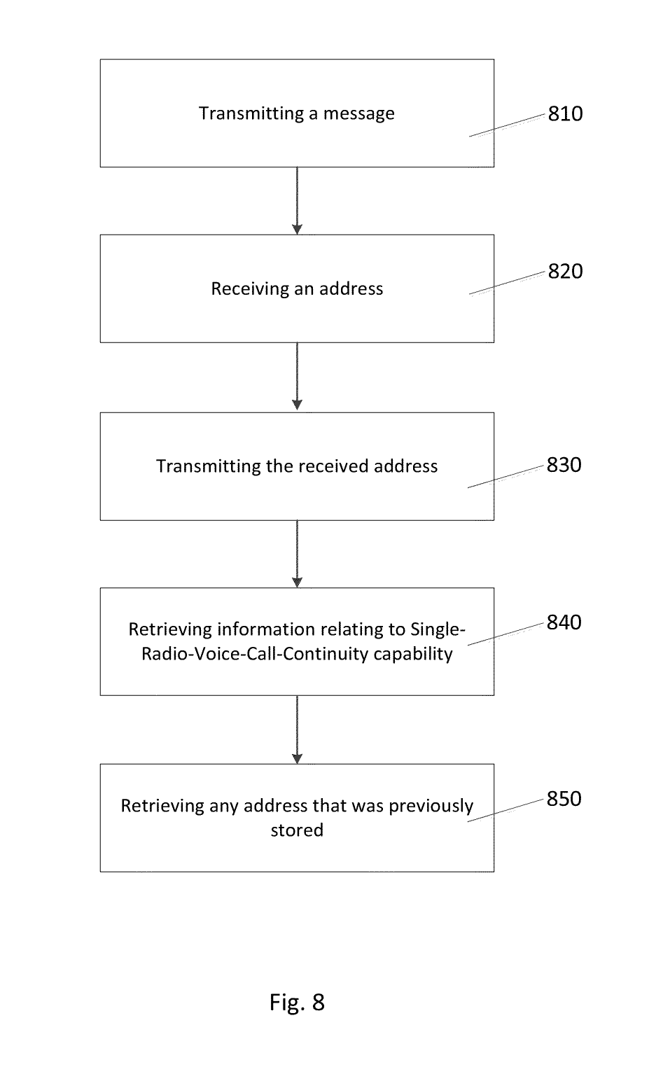

FIG. 8 illustrates a flowchart of a method in accordance with embodiments of the invention. The method illustrated in FIG. 8 includes, at 810, transmitting, by a Service-Centralization-and-Continuity Application Server, a message to an Access Transfer Control Function. The method may also include, at 820, receiving an address from the Access Transfer Control Function. The method may also include, at 830, transmitting the received address to a Home-Subscriber Server, wherein the address is stored as a Session-Transfer Number. The method may also include, at 840, retrieving information relating to Single-Radio-Voice-Call-Continuity capability. The method may also include, at 850, retrieving any address that was previously stored as a Session-Transfer-Number.

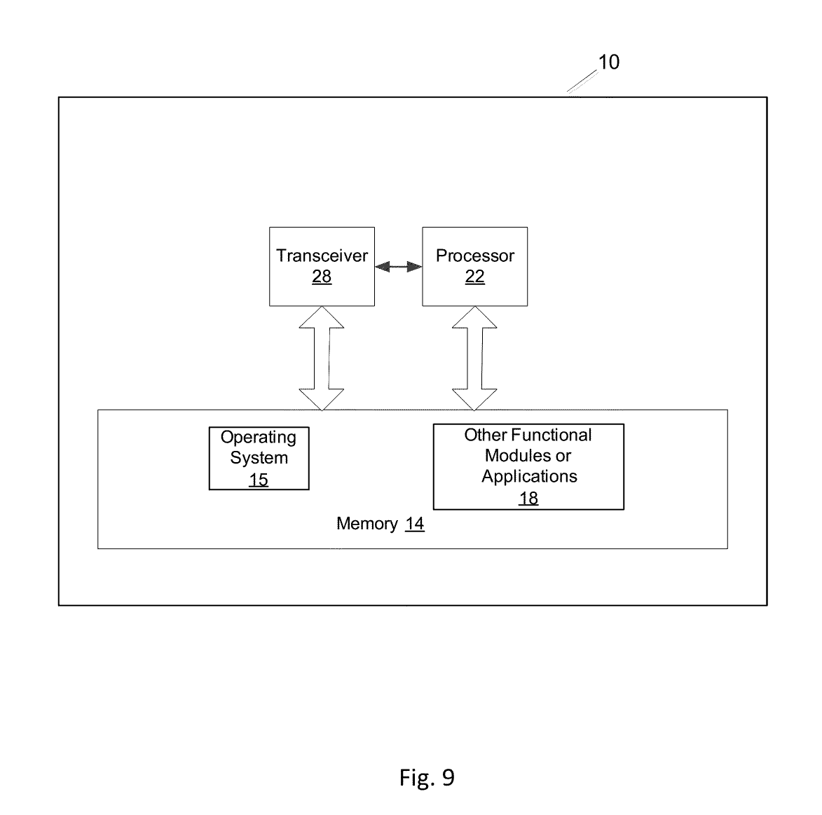

FIG. 9 illustrates an apparatus in accordance with embodiments of the invention. In one embodiment, the apparatus can be a network element, such as an SCC AS, for example. Apparatus 10 can include a processor 22 for processing information and executing instructions or operations. Processor 22 can be any type of general or specific purpose processor. While a single processor 22 is shown in FIG. 9, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 includes any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

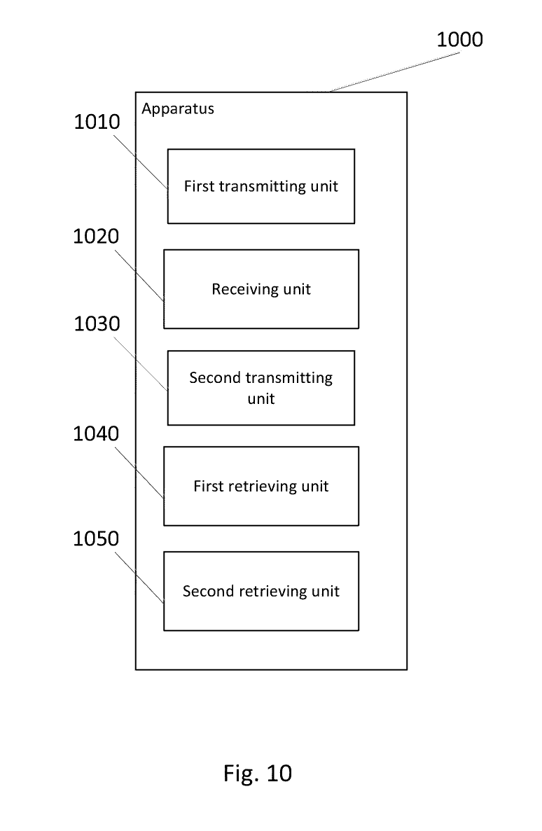

FIG. 10 illustrates an apparatus in accordance with embodiments of the invention. Apparatus 1000 can be a network element/entity such as an SCC AS, for example. Apparatus 1000 can include a first transmitting unit 1010 that transmits a message to an Access Transfer Control Function. Apparatus 1000 may also include a receiving unit 1020 that receives an address from the Access Transfer Control Function. Apparatus 1000 may also include a second transmitting unit 1030 that transmits the received address to a Home-Subscriber Server. The address is stored as a Session-Transfer Number. Apparatus 1000 may also include a first retrieving unit 1040 that retrieves information relating to Single-Radio-Voice-Call-Continuity capability. Apparatus 1000 may also include a second retrieving unit 1050 that retrieves any address that was previously stored as a Session-Transfer-Number.

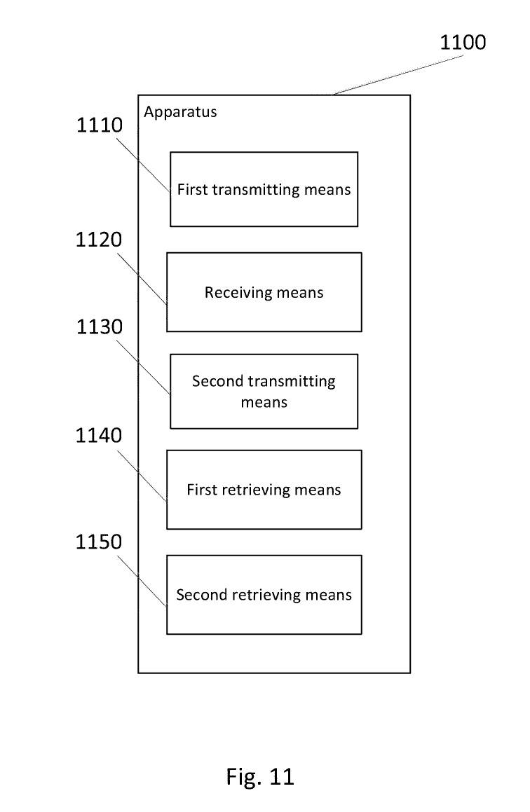

FIG. 11 illustrates an apparatus in accordance with embodiments of the invention. Apparatus 1100 can be a network element/entity such as an SCC AS, for example. Apparatus 1100 can include a first transmitting means 1110 that transmits a message to an Access Transfer Control Function. Apparatus 1100 may also include a receiving means 1120 that receives an address from the Access Transfer Control Function. Apparatus 1100 may also include a second transmitting means 1130 that transmits the received address to a Home-Subscriber Server. The address is stored as a Session-Transfer Number. Apparatus 1100 may also include a first retrieving means 1140 that retrieves information relating to Single-Radio-Voice-Call-Continuity capability. Apparatus 1100 may also include a second retrieving means 1150 that retrieves any address that was previously stored as a Session-Transfer-Number.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
transmitting, by a Service-Centralization-and-Continuity Application Server, a message to an Access Transfer Control Function;
receiving an address from the Access Transfer Control Function;
transmitting the received address to a Home-Subscriber Server, wherein the address is stored as a Session-Transfer Number;
retrieving information relating to Single-Radio-Voice-Call-Continuity capability; and
retrieving any address that was previously stored as a Session-Transfer-Number.

2. The method according to claim 1, wherein the transmitting the message comprises transmitting an SIP message.

3. The method according to claim 1, wherein the retrieving the information and the retrieving the any address that was previously stored comprises retrieving via an Sh interface.

4. The method according to claim 1, wherein the retrieving the information and the retrieving the any address that was previously stored comprises retrieving from the Home-Subscriber Server.

5. The method according to claim 1, further comprising updating the stored Session-Transfer Number if the address received from the Access Transfer Control Function is different from the address retrieved from the Home-Subscriber Server.

6. An apparatus, comprising:
at least one processor; and
at least one memory including computer program code,
the at least one memory and the computer program code configured, with the at least one processor, to cause the apparatus at least to
transmit a message to an Access Transfer Control Function;
receive an address from the Access Transfer Control Function;
transmit the received address to a Home-Subscriber Server, wherein the address is stored as a Session-Transfer Number;
retrieve information relating to Single-Radio-Voice-Call-Continuity capability; and
retrieve any address that was previously stored as a Session-Transfer-Number.

7. The apparatus according to claim 6, wherein the transmitting the message comprises transmitting an SIP message.

8. The apparatus according to claim 6, wherein the retrieving the information and the retrieving the any address that was previously stored comprises retrieving via an Sh interface.

9. The apparatus according to claim 6, wherein the retrieving the information and the retrieving the any address that was previously stored comprises retrieving from the Home-Subscriber Server.

10. The apparatus according to claim 6, wherein the apparatus is further caused to update the stored Session-Transfer Number if the address received from the Access Transfer Control Function is different from the address retrieved from the Home-Subscriber Server.

11. A computer program product, embodied on a non-transitory computer readable medium, the computer program product configured to control a processor to perform a process comprising:
transmitting, by a Service-Centralization-and-Continuity Application Server, a message to an Access Transfer Control Function;
receiving an address from the Access Transfer Control Function;
transmitting the received address to a Home-Subscriber Server, wherein the address is stored as a Session-Transfer Number;
retrieving information relating to Single-Radio-Voice-Call-Continuity capability; and
retrieving any address that was previously stored as a Session-Transfer-Number.

12. The computer program product according to claim 11, wherein the transmitting the message comprises transmitting an SIP message.

13. The computer program product according to claim 11, wherein the retrieving the information and the retrieving the any address that was previously stored comprises retrieving via an Sh interface.

14. The computer program product according to claim 11, wherein the retrieving the information and the retrieving the any address that was previously stored comprises retrieving from the Home-Subscriber Server.

15. The computer program product according to claim 11, wherein the process further comprises updating the stored Session-Transfer Number if the address received from the Access Transfer Control Function is different from the address retrieved from the Home-Subscriber Server.
